(19) United States
(12) Patent Application Publication
(10) Pub. No.: US 2011/0247168 A1
(43) Pub. Date: Oct. 13, 2011

(54) METHOD OF INSPECTION AND CLEANING MEDICAL, SURGICAL, AND VETERINARY INSTRUMENTS AND AN INSPECTION MAT FOR USE IN THE METHOD

(75) Inventor: Richard John Schultz, Hudson, OH (US)

(73) Assignee: Spectrum Surgical Instruments Corp.

(21) Appl. No.: 12/757,366

(22) Filed: Apr. 9, 2010

(51) Int. Cl. B05C 21/00

(52) U.S. Cl. 15/257.01

(57) ABSTRACT

A method of controlling the quality of inspection and cleaning of surgical, medical, and veterinary instruments includes gathering illustrations of the instruments to be cleaned and inspected. Portion of the instruments most subject to wear and retention of contamination are identified and marked on the illustrations. The illustrations are annotated with instructions on inspection and cleaning with reference to the marked portions. The annotated illustrations are positioned on an upper surface of a resilient, smoother, waterproof mat.

### BACKGROUND OF THE DISCLOSURE

The present exemplary embodiment relates to a method of inspecting and cleaning medical, surgical, and veterinary instruments and an inspection mat used in the inspection and cleaning of surgical, medical and veterinary instruments and more particularly to an inspection mat used in controlling the quality of inspection and cleaning of surgical, medical and veterinary instruments. However, it is to be appreciated that the present exemplary embodiment is also amenable to other like applications.

Surgical, medical and veterinary instruments are often complex in shape, expensive and include tubes, apertures or passages. These instruments are often reused. The instruments must be cleaned and sterilized between uses. Improperly cleaned or sterilized instruments may contribute to postoperative infections or mortality. Furthermore, if instruments are not inspected periodically, sharpened or tightened, etc. as required, they will begin to work out of their design parameters and need replacing more quickly.

Thus, a need exists for an improved method and apparatus for controlling the quality inspection and cleaning of surgical, medical and veterinary instruments.

### SUMMARY OF THE DISCLOSURE

In one aspect, the present disclosure relates to a method of controlling the quality of inspection and cleaning of surgical, medical and veterinary instruments that includes gathering illustrations of the instruments to be cleaned and inspected. The portions of the instruments are identified which are most subject to wear and retention of contamination and these portions are marked on the illustrations. The illustrations are annotated with instructions on inspection and cleaning with reference to the marked portions. The annotated illustrations are positioned on an upper surface of a resilient, smooth, waterproof mat.

In another aspect, the present disclosure relates to an inspection mat to control the quality of inspection and cleaning of surgical, medical and veterinary instruments that includes illustrations of the instruments gathered to be cleaned and inspected. The portions of the instruments most subject to wear and retention of contamination are identified and marked on the illustrations. The illustrations are annotated with instructions on inspection and cleaning with reference to the marked portions. The annotated illustrations are positioned on an upper surface of a resilient, smooth and waterproof mat.

In yet another aspect, the present disclosure relates to a method of controlling the quality of inspection and cleaning of surgical, medical and veterinary instruments that includes gathering illustrations of the instruments to be cleaned and inspected. The method further includes gathering illustrations of the instruments testing procedures and standards. The portions of the instruments are identified which are most subject to wear and retention of contamination and these portions are marked on the illustrations. The illustrations are annotated with instructions on inspection and cleaning with reference to the marked portions. The testing illustrations are annotated with instructions on the procedures and standards. The annotated illustrations and annotated testing illustrations are positioned on an upper surface of a resilient, smooth, waterproof mat.

A primary benefit of the present disclosure is providing information for controlling the quality of inspection and cleaning of surgical, medical and veterinary instruments at the point of work.

Another benefit of the present disclosure is providing testing procedures and standards of surgical, medical and veterinary instruments at the point of work.

Yet another benefit of the present disclosure is providing a resilient mat in order to reduce the risk of damage to the surgical, medical and veterinary instruments.

Still further features and advantages will become apparent to those of ordinary skill in the art upon reading and understanding the following detailed description of the preferred embodiment.

### BRIEF DESCRIPTION OF THE DRAWINGS

FIG. 1 is a schematic perspective view of an inspection mat according to an exemplary embodiment.

FIG. 2 is an enlarged schematic perspective view of an Iris Scissor Instrument illustration according to an exemplary embodiment;

FIG. 3 is an enlarged schematic perspective view of a Rongeurs Instrument illustration according to an exemplary embodiment;

FIGS. 4-6 are enlarged views of portions of the mat of FIG. 1;

FIG. 7 is a flowchart for a method of controlling the quality of inspection and cleaning of surgical, medical, and veterinary instruments and an inspection mat for use in the method according to an exemplary embodiment; and,

FIG. 8 is a flowchart for a method of controlling the quality of inspection and cleaning of surgical, medical, and veterinary instruments and an inspection mat for use in the method relating to instrument sharpness testing standards according to an exemplary embodiment.

### DETAILED DESCRIPTION OF THE PREFERRED EMBODIMENTS

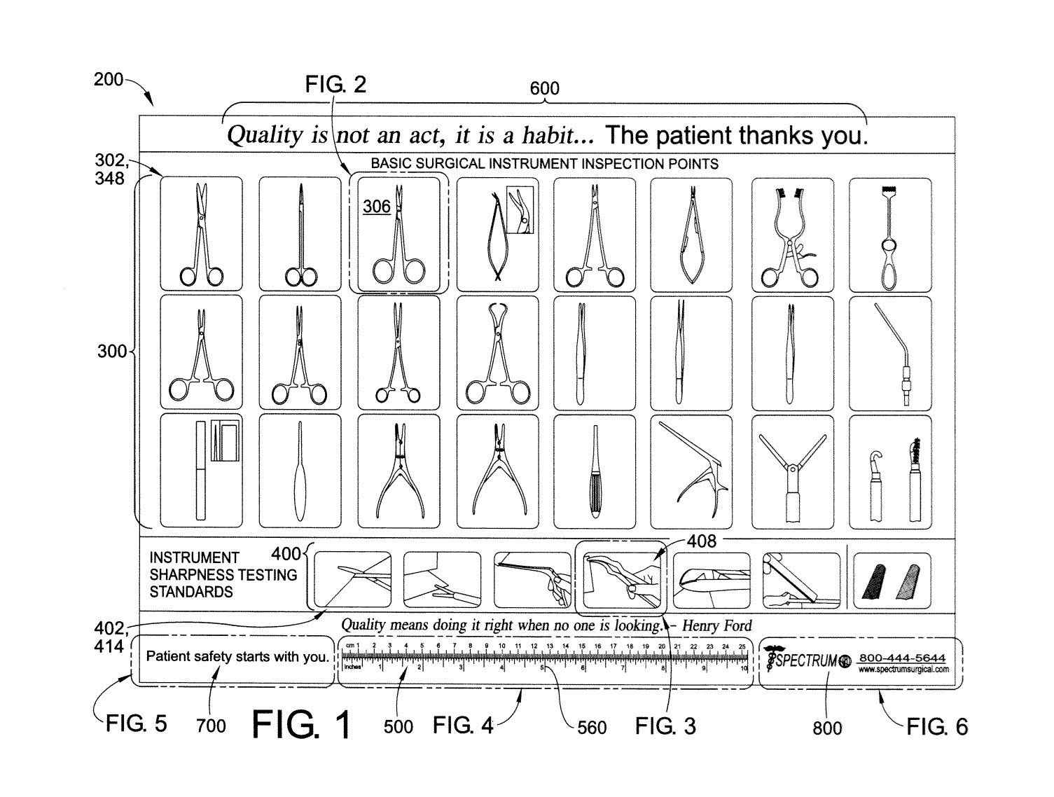

Referring now to the drawing wherein the showing is for the purposes of illustrating a preferred embodiment of the present disclosure and not for the purposes of limited same, FIG. 1 illustrates an inspection mat 200 to control the inspection and cleaning of surgical, medical and veterinary instruments. A basic surgical instrument inspection point space 300 includes gathered illustrations of the instruments 302-348. In an exemplary embodiment, the instruments may include surgical, medical, and veterinary instruments, and combinations thereof to be cleaned and inspected. The inspection space 300 as shown may include up to twenty four illustrations or more, of instruments. It may be appreciated, that the size of the inspection mat 200 may determine the number of illustrations gathered within an inspection space 300.

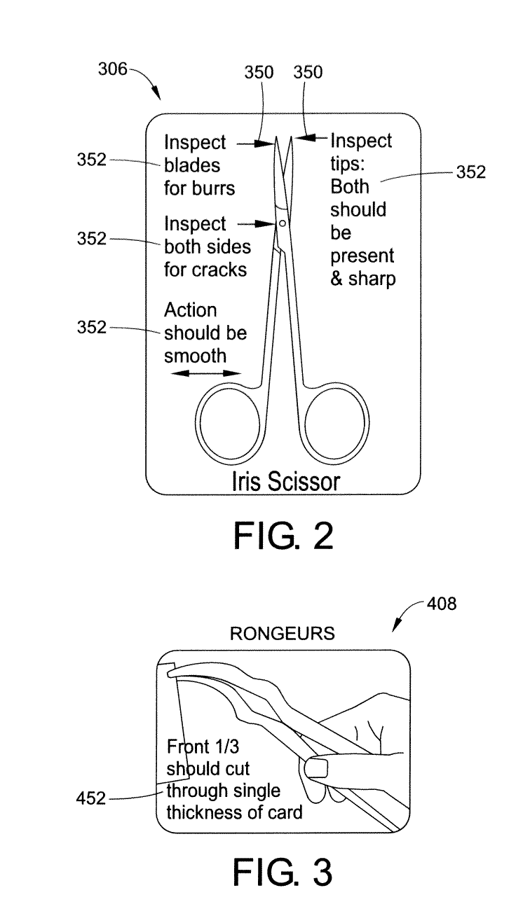

For ease of illustration, FIG. 2 is an enlargement of an illustration of an Iris scissor instrument illustration 306. The illustration 306 includes marked portions of the instrument most subject to wear and retention of contamination. In this embodiment, the marked portions are identified by arrows 350. The scissor instrument illustration 306 is annotated with instructions 352 on inspection and cleaning with reference to the marked portions. It should be appreciated, that illustrations 302, 304, and 308-348 are identified, marked and annotated in a similar manner.

In an exemplary embodiment, the annotated illustrations 302-348, as illustrated in FIG. 1, are positioned on an upper surface of a smooth, waterproof mat 200 within space 300. In another embodiment, the mat 200 may also be resilient in order to reduce the risk of damage to the surgical, medical, and veterinary instruments.

An instrument sharpness testing standards space 400, as illustrated in FIG. 1, provides the testing procedures and standards. The standards and procedures are presented with graphics in the gathered illustrations of the instruments 402-414. For illustration purposes, FIG. 3 show an illustration of an enlarged perspective view of a testing illustration annotated with instructions 452 for a Rongeurs instrument testing illustration 408. It should be appreciated, that illustrations 402-406 and 420-414 are annotated in a similar manner. As shown in FIG. 1, the annotated illustrations 402-414 are positioned on the upper surface of the mat 200 within space 400.

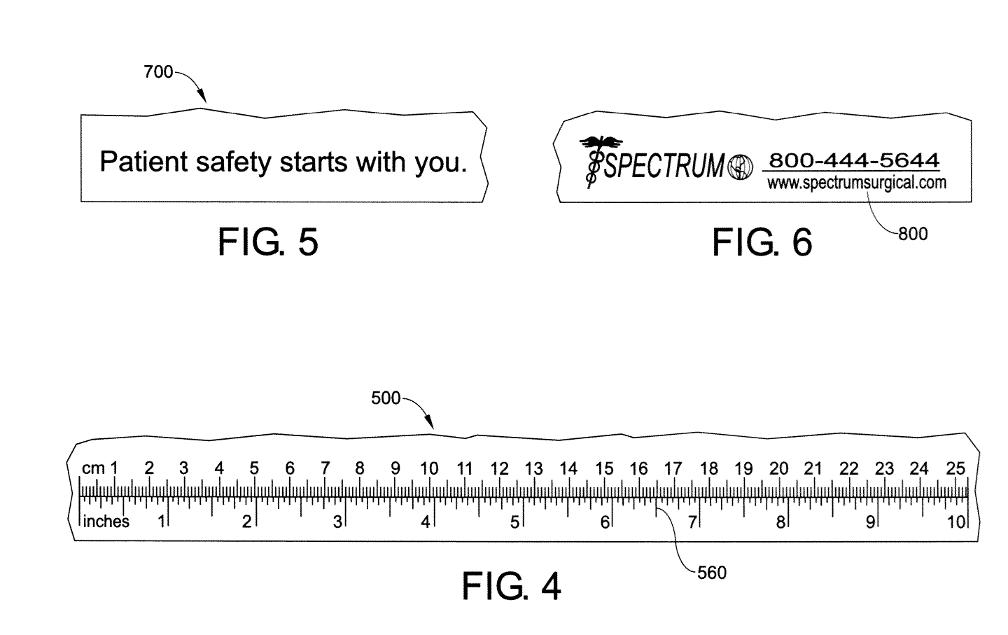

A measuring indicia space 500 includes a graphical measuring device 560 in order to check for proper sizes of the instruments 302-348. For illustration purposes, FIG. 4 is an enlarged perspective view of the measuring indicia space 500 having a graphical measuring device 560 or ruler. The graphical measuring device 560 or ruler is positioned on the upper surface of the mat 200 within the space 500. Other graphical measuring devices may be used. For instance, an inspection mat to be used in inspecting suture needles may have labeled illustrations of various curved suture needles to scale.

FIG. 1 further illustrates spaces 600,700 that may include quality statements and space 800 may include contact information for questions and help on the mat 200. For ease of illustration, FIGS. 5 and 6 are enlarged perspective views of spaces 700 and 800.

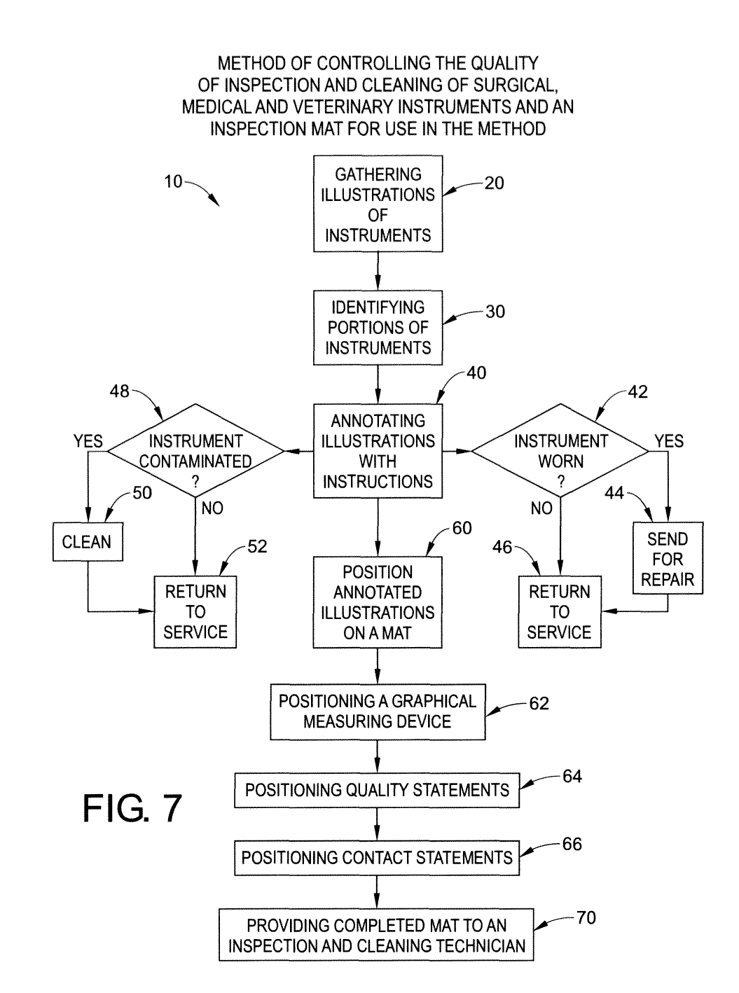

FIG. 7 is a flowchart illustrating a method 10 of inspection and cleaning medical, surgical, and veterinary instruments and an inspection mat for use in the method. The method disclosed provides quality control benefits. The method 10 includes providing a mat having the step of gathering illustrations of instruments S20 (302-348) within a basic surgical instrument inspection point space 300. In an exemplary embodiment, the instruments may include surgical, medical, and veterinary instruments, and combinations thereof to be cleaned and inspected. The inspection space 300 as shown in FIG. 1 may include up to twenty four illustrations or more, of instruments. It may be appreciated that the size of the inspection mat 200 may determine the number of illustrations gathered within an inspection space 300.

The method 10 also includes providing a mat having the step of identifying portions of the instruments S30 most subject to wear and retention of contamination and marking these portions on the illustrations. In an embodiment, the marked portions are identified by arrows 350 as shown in FIG. 2.

The method 10 further includes providing a mat having the step of annotating the illustrations with instructions S40. As illustrated in FIG. 2, the scissor instrument 306 is annotated with instructions 352 on inspection and cleaning with reference to the marked portions. The arrows 350 may identify specific areas of the instrument requiring inspection and cleaning as for example, inspect blades for burrs, inspect tips, inspect, both sides for cracks, action should be smooth, etc. The method 10 includes providing a mat having decision (branching) steps driven by the annotations 352 of S40. A worn instrument S42 is sent out for repair S44 by an inspection technician. An unworn (already repaired or not in need of repair) instrument S42 is returned to service S46. Similarly, a contaminated instrument S48 is cleaned S50. An uncontaminated (already cleaned) instrument S48 is returned to service S52. It may be appreciated, an instrument working out of its design parameter may need to be replaced or taken out of service permanently.

The method may further include providing a mat having the step of positioning a graphical measuring device S62. The graphical measuring device is positioned within the measuring indicia space 500 on the upper surface of the inspection mat 200 as illustrated in FIG. 1. The graphical measuring device 560 or ruler may be needed in order to check for proper sizes of the instruments 302-348. Other graphical measuring devices may be used as previously described.

The method 10 may further include providing a mat having the step of positioning quality statements S64 within the spaces 600, 700 on the upper surface of the inspection mat 200 as illustrated in FIG. 1. The quality statements may explain the effectiveness and efficiency of the method of controlling the quality of inspection and cleaning of surgical, medical and veterinary instruments.

The method 10 may further include providing a mat having the step of positioning contact statements S66 within the space 800 on the upper surface of the inspection mat 200 as illustrated in FIG. 1. Contact statements provide a technician with information needed to address inspection or cleaning issues not fully addressed in the pad 200. A technician faced with an instrument worn or contaminated in an unexpected manner is provided with contact points to address the issue and maintain the quality of inspection and cleaning. Contact statements may include a website, logo and customer service phone number, email address and fax number for an approved service provider. Contact statements allow a technician to contact a service provider directly for specialized service. The service provider may provide documented, specialized advice and instructions to the technician, for example, relating to the inspection and cleaning of their medical, surgical, and veterinary instruments and combinations thereof.

The method 10 may further include providing a completed inspection mat to an inspection and cleaning technician S70. The inspection and cleaning technician may further position the inspection mat on a workbench area within a laboratory setting. This would allow for ease of use and immediacy of process control while inspecting and cleaning the instruments.

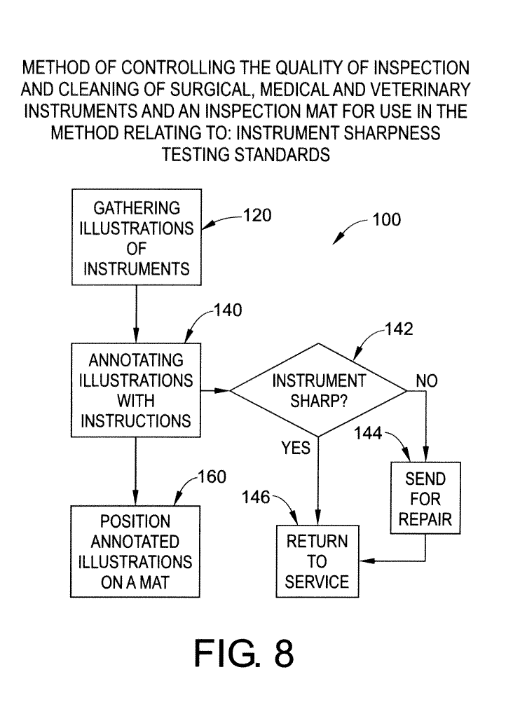

FIG. 8 is a flowchart illustrating a method 10 of inspection and cleaning medical, surgical, and veterinary instruments and an inspection mat for use in the method relating to instrument sharpness testing standards. The method 10 includes providing a mat having the step of gathering illustrations of instruments S120 (402-414) within an instrument sharpness testing standards space 400. In an exemplary embodiment, the instruments may include surgical, medical, and veterinary instruments, and combinations thereof to be cleaned and inspected. The standards space 400 as shown in FIG. 1 may include up to seven illustrations or more, of instruments. It may be appreciated that the size of the inspection mat 200 may determine the number of illustrations gathered within a standards space 400.

The method 10 further includes providing a mat having the step of annotating the illustrations with instructions S40. As illustrated in FIG. 3, the Rongeurs' instrument 306 is annotated with instructions 452 on instrument sharpness testing procedures and standards with reference to the marked portions. The annotated portion(s) may indicate how an instrument should cut, for example, should cut smoothly through to tip without snagging, should cut cleanly through facial tissue, should cut cleanly through single thickness of index card, etc. An unsharp instrument S142 is sent for repair S144. A sharp instrument S142 is returned to service S146. It may be appreciated, an instrument working out of its design parameter may need to be replaced or taken out of service permanently.

The method 10 further includes providing a mat having the step of positioning the annotated illustrations S160 on an upper surface of a resilient, smooth, waterproof mat.

The methods described may be performed by different organizations. For example, a first service organization may prepare the mat 200 including gathering and preparing all illustrations, annotations, and other markings. A second service provider such as a hospital, veterinary practice, or medical practice may provide the mat to technicians for use in inspection and cleaning.

It will be appreciated that variants of the above-disclosed and other features and functions, or alternatives thereof, may be combined into many other different systems or applications. Various presently unforeseen or unanticipated alternatives, modifications, variations, or improvements there in may be subsequently made by those skilled in the art which are also intended to encompassed by the following claims.

1. A method of controlling the quality of inspection and cleaning of surgical, medical and veterinary instruments comprising:
gathering illustrations of the instruments to be cleaned and inspected;
identifying portions of the instruments most subject to wear and retention of contamination and marking these portions on the illustrations;
annotating the illustrations with instructions on inspection and cleaning with reference to the marked portions; and
positioning the annotated illustrations on an upper surface of a resilient, smooth, waterproof mat.

2. The method of claim 1 further comprising:
gathering illustrations of the instruments testing procedures and standards;
annotating the testing illustrations with instructions on the procedures and standards; and
positioning the annotated testing illustrations on the upper surface of the mat.

3. The method of claim 1 further comprising positioning a graphical measuring device on the upper surface of the mat.

4. The method of claim 1 further comprising positioning quality statements on the mat.

5. The method of claim 1 further comprising positioning contact information for questions and help on the mat.

6. The method of claim 1 further providing the completed mat to an inspection and cleaning technician as a work surface.

7. An inspection mat to control the quality of inspection and cleaning of surgical, medical and veterinary instruments comprising:
illustrations gathered of the instruments to be cleaned and inspected;
portions identified of the instruments most subject to wear and retention of contamination and these portions marked on the illustrations;
illustrations annotated with instructions on inspection and cleaning with reference to the marked portions; and
the annotated illustrations positioned on an upper surface of a resilient, smooth, waterproof mat.

8. The inspection mat of claim 7 further comprising:
illustrations gathered of the instruments testing procedures and standards;
the testing illustrations annotated with instructions on the procedures and standards; and
the annotated testing illustrations positioned on the upper surface of the mat.

9. The inspection mat of claim 7 further comprising quality statements positioned on the mat.

10. The inspection mat of claim 7 further comprising contact information for questions and help positioned on the mat.

11. The inspection mat of claim 7 wherein the completed mat is provided to an inspection and cleaning technician as a work surface.

12. A method of controlling the quality of inspection and cleaning of surgical, medical and veterinary instruments comprising:
gathering illustrations of the instruments to be cleaned and inspected;
gathering illustrations of the instruments testing procedures and standards;
identifying the portions of the instruments most subject to wear and retention of contamination and marking these portions on the illustrations;
annotating the illustrations with instructions on inspection and cleaning with reference to the marked portions;
annotating the testing illustrations with instructions son the procedures and standards; and,
positioning the annotated illustrations and annotated testing illustrations on an upper surface of a resilient, smooth, waterproof mat.

13. The method of claim 12 further comprising positioning a graphical measuring device on the upper surface of the mat.

14. The method of claim 12 further comprising positioning quality statements on the mat.

15. The method of claim 12 further comprising positioning contact information for questions and help on the mat.

16. The method of claim 12 further providing the completed mat to an inspection and cleaning technician as a work surface.

17. The method of claim 12 wherein the mat is padded.
